(19) United States
(12) Patent Application Publication
(10) Pub. No.: US 2009/0021334 A1
(43) Pub. Date: Jan. 22, 2009

(54) ELECTROMAGNETIC ACTUATOR

(75) Inventor: Nobuhide Okada, Saitama (JP)

Correspondence Address: CARTER, DELUCA, FARRELL & SCHMIDT, LLP, 445 BROAD HOLLOW ROAD, SUITE 420, MELVILLE, NY, 11747, US

(73) Assignee: SHINDENGEN MECHATRONICS CO., LTD, Hannou-shi, Saitama (JP)

(21) Appl. No.: 11/911,880

(22) PCT Filed: Apr. 14, 2006
(86) PCT No.: PCT/JP2006/307929

§ 371 Date: Nov. 28, 2007

(30) Foreign Application Priority Data
Apr. 19, 2005 (JP) 2005-121009

(51) Int. Cl. H01F 7/08; H01F 7/13

(52) U.S. Cl. 335/289; 335/230

(57) ABSTRACT

An electromagnetic actuator comprising a fixed magnetic pole (11) applied with an electromagnetic coil (14), and a movable magnetic pole (20) provided in the insertion hole (12) of the fixed magnetic pole movably in the axial direction. The movable magnetic pole is provided with a projecting portion (22) tapered along its moving direction, a recessed taper portion (13) corresponding to the projecting taper portion of the movable magnetic pole is formed at the insertion hole of the fixed magnetic pole, and a tubular auxiliary magnetic pole (40) extending in the axial direction from the opening end of the recessed taper portion is provided continuously to the fixed magnetic pole.

### TECHNICAL FIELD

The present invention relates to an electromagnetic actuator for driving a load and particularly to the electromagnetic actuator, wherein a movable magnetic pole is provided in the fixed magnetic pole and is movable along the axial direction.

### BACKGROUND ART

Generally, it is required that the electromagnetic actuators employed for machinery and tools such as electronic locks and printers and so on have various characteristics such as great attracting forces in spite of the small sizes, small magnetic fluxes leaking outside, and moreover small operation noises. The above-mentioned electromagnetic actuators have been devised, for example, in regard to their surface shapes facing between the fixed magnetic pole and the movable magnetic pole as a plunger (for example, cf., Patent Document 1 and Patent Document 2).

For example, the electromagnetic actuator as shown in FIG. 11, has a fixed magnetic pole 51 of substantially cylinder-shape made of magnetic material, and has an electromagnetic coil 52, whereby a movable magnetic pole 55 is movably inserted along the axial direction into an insertion hole 53.

Thus, when a DC electric current is supplied into the electromagnetic coil 52, a magnetic flux is induced and a magnetic circuit is formed through the electromagnetic coil 52, the movable magnetic pole 55, and the fixed magnetic pole 51. As a result, a propulsion force is exerted on the movable magnetic pole 55 so as to move the movable magnetic pole 55 from the right side to the left side along the axial direction as shown in the drawing. Accordingly, the movable magnetic pole 55 is operated along the axial direction.

In this case, there is provided, at the anterior edge of the movable magnetic pole 55, a convex tapered portion 56 tapered toward the anterior direction of the operation direction, while there is provided, at the posterior edge portion of the insertion hole 53 (right side as shown in the drawing), a concave tapered portion 57 in correspondence to the convex taped portion 56, whereby the concave tapered portion 57 of the fixed magnetic pole 51 and the convex tapered portion 56 of the movable magnetic pole 55 can lengthen the operation length of the movable magnetic pole 55. An output axis 58 is unified with the movable magnetic pole 55.

Further, in order to further lengthen the operation distance, some of the electromagnetic actuators, as shown in FIG. 12, are designed so as to decrease both the angle of the convex tapered portion 56 of the movable magnetic pole 55 and the angle of the concave tapered portion 57 of the fixed magnetic pole 51, thereby making more longer both the tapered portions 56 and 57 along the axial direction.

Patent Document 1: Japanese Utility Model No. 2526713

Patent Document 2: Japanese Unexamined Patent Application Publication No. Hei 9-17630

### DISCLOSURE OF THE INVENTION

### Problems to be Solved by the Invention

As stated above, in the examples as shown in FIG. 11 and FIG. 12, due to the tapered portions 56 and 57 provided in the movable magnetic pole 55 and the fixed magnetic pole 51, respectively, the operation distance of the movable magnetic pole 55 can be made long. However, the above-mentioned examples have a disadvantage that a further decrease in the angles of the tapered portions 56 and 57 is limited. Therefore, the requirement today to obtain further longer operation distance is hard to achieve.

In place of a linear motion type solenoid, some of the conventional techniques employ a rotary solenoid or motor, and moreover combine the above-mentioned rotation mechanism with a rotation-to-linear motion conversion mechanism for converting a rotation motion to a linear motion, thereby seeking to obtain the above-mentioned longer operation distance. However, such a device has a disadvantage that the internal structure becomes complicated and the apparatus as a whole becomes large-sized.

Particularly, the electromagnetic actuators employed for the machinery and tools such as the electronic locks, printers and have recently been made extremely compact but the longer operation distance has been yet desired.

Taking these circumstances into consideration, an object of the present invention is to provide an electromagnetic actuator, wherein the operation distance can be surely made longer and the movable magnetic pole can be stably operated under a simple structure without combining any special conversion mechanism and so on.

### Means for Solving the Problems

In order to achieve the above-mentioned object, the present invention proposes the following solving means. That is, the present invention is an electromagnetic actuator, comprising: an insertion hole along an axial direction of the electromagnetic actuator; a fixed magnetic pole provided with an electromagnetic coil; a movable magnetic pole movable along the axial direction of the insertion hole; a convex magnetic pole portion provided at either one of the fixed magnetic pole or the movable magnetic pole and projected toward another one of the fixed magnetic pole or the movable magnetic pole; and a concave magnetic pole portion formed at said another one of the fixed magnetic pole or the movable magnetic pole in correspondence to the convex magnetic pole portion, characterized in that an auxiliary magnetic pole is continuously provided at the concave magnetic pole portion and is extended from an opening edge of the concave magnetic pole portion.

According to the above-mentioned invention, even in the case where the distance between the concave magnetic pole portion and the convex magnetic pole portion along the axial direction is great at the time when an electric current is supplied into the electromagnetic coil, the magnetic flux is generated between the concave magnetic pole portion and the auxiliary magnetic pole, due to the presence of the auxiliary magnetic pole provided at and extended from the concave magnetic pole portion. As a result, the movable magnetic pole can be operated.

That is, the above-mentioned two flow routes of magnetic fluxes are generated between the fixed magnetic pole and the movable magnetic pole. At the initial stage of the operation, the movable magnetic pole is moved by one of the magnetic fluxes between the auxiliary magnetic pole and the convex magnetic pole, while at the latter half of the operation the movable magnetic pole is moved by another magnetic flux generated between the concave magnetic pole portion and the convex magnetic pole portion.

Here, tapered members and stepped members and so on may be employed for the convex magnetic pole portion and the concave magnetic portion.

In this case, the auxiliary magnetic pole is provided at and extended from the concave magnetic pole portion, thereby generating a magnetic flux along the radial direction between the auxiliary magnetic pole and the convex magnetic pole, when the convex magnetic pole portion enters into the auxiliary magnetic pole. As a result, the propulsion force exerted on the movable magnetic pole is dispersed along the radial direction together with its moving direction. As a result, the propulsion force reduces more and more.

Therefore, if the above-explained decrease in the propulsion force is required to be suppressed, it may be preferable that a nonmagnetic member is disposed between the concave magnetic pole portion and the auxiliary magnetic pole.

According to the above-mentioned structure, when the convex magnetic pole portion enters into the auxiliary magnetic pole, the magnetic flux between the convex magnetic pole portion and the concave magnetic pole portion acts dominantly, because the magnetic flux between the convex magnetic pole portion and the auxiliary magnetic pole along the radial direction is small. As a result, a greater propulsion force can be generated. Of course, due to the presence of the auxiliary magnetic pole provided at and extended from the concave magnetic pole, a magnetic force is exerted between the convex magnetic pole portion and the auxiliary magnetic pole. As a result, a greater operation distance can be surely held.

The nonmagnetic member may be of ring-shaped nonmagnetic material, or may be an air gap provided between the concave magnetic pole portion and the auxiliary magnetic pole.

Further, the above-mentioned auxiliary magnetic pole may have such a structure that the auxiliary magnetic pole is divided into a plurality of parts along the circumferential direction side.

According to the present invention, the present invention obtains an advantage that due to the presence of the auxiliary magnetic pole continuously provided at and extended from the concave magnetic pole portion, the magnetic force can be exerted, through the auxiliary magnetic pole, on the convex magnetic pole, even in the case where the distance between the concave magnetic pole portion and the convex magnetic pole portion is great. Therefore, the present invention can obtain an advantage that the operation distance can surely be made greater by a simple structure and without providing any special conversion mechanism, and also can obtain an advantage that the electromagnetic actuator as a whole can be made compact-sized.

Further, the present invention can obtain another advantage that an excellent propulsion force can be obtained over an entire range of the operation distance, because the decrease in the propulsion force exerted on the movable magnetic pole can be suppressed at the latter half of the operation distance, due to such a structure that the nonmagnetic member is provided between the concave magnetic pole portion and the auxiliary magnetic pole. As a result, the present invention can obtain further advantage that a versatility of uses can be increased more and more.

### BRIEF DESCRIPTION OF THE DRAWINGS

FIG. 1 is a cross sectional view of an electromagnetic actuator of a first embodiment of the present invention.

FIG. 2 illustrates the relation between the initial state and the magnetic flux of the electromagnetic actuator as shown in FIG. 1.

FIG. 3 illustrates the relation between a halfway operation state and the magnetic flux of the electromagnetic actuator as shown in FIG. 1.

FIG. 4 illustrates the relation between a state of the movable magnetic pole further moved from the state as shown in FIG. 3 and the magnetic flux.

FIG. 5 is a cross sectional view of an electromagnetic actuator of a second embodiment of the present invention.

FIG. 6 illustrates the relation between the initial state and the magnetic flux of the electromagnetic actuator as shown in FIG. 5.

FIG. 7 illustrates the relation between a halfway operation state and the magnetic flux of the electromagnetic actuator as shown in FIG. 5.

FIG. 8 illustrates the relation between a state of the movable magnetic pole further moved from the state as shown in FIG. 7 and the magnetic flux.

FIG. 9 illustrates the relation between other state of the movable magnetic pole furthermore moved from the state as shown in FIG. 8 and the magnetic flux.

FIG. 10 shows each characteristic curve of the operation distance vs. propulsion force of the electromagnetic actuator of each embodiment.

FIG. 11 is a cross sectional view of a first example of the conventional electromagnetic actuator.

FIG. 12 is a cross sectional view of a second example of the conventional electromagnetic actuator.

### PREFERRED MODE FOR CARRYING OUT THE INVENTION

In the following, referring to the drawings, the embodiments of the present invention are explained.

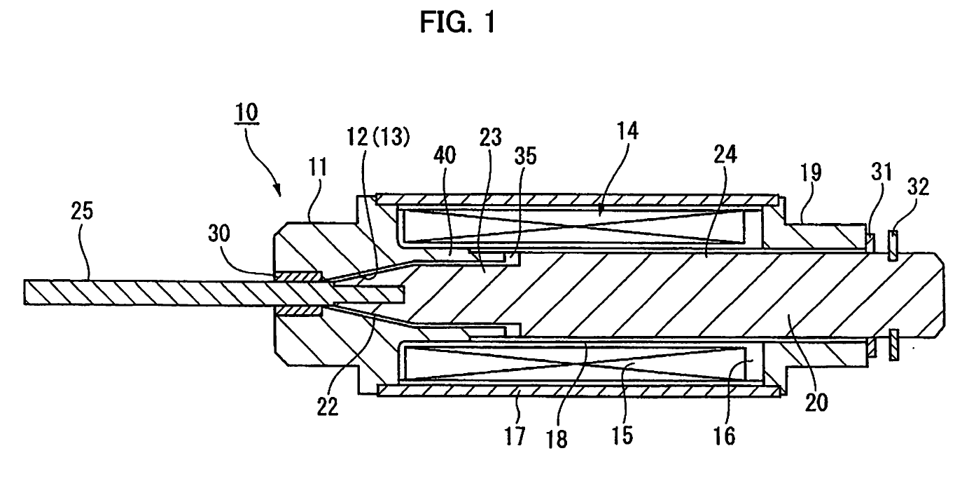

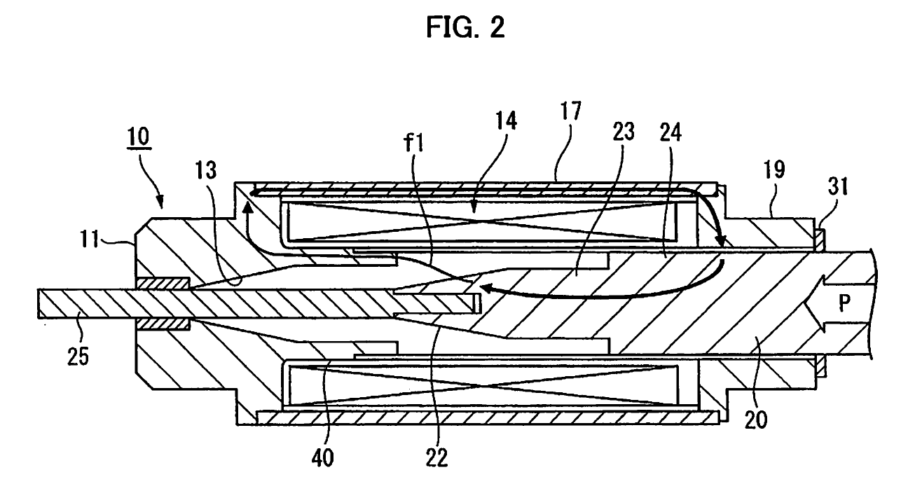

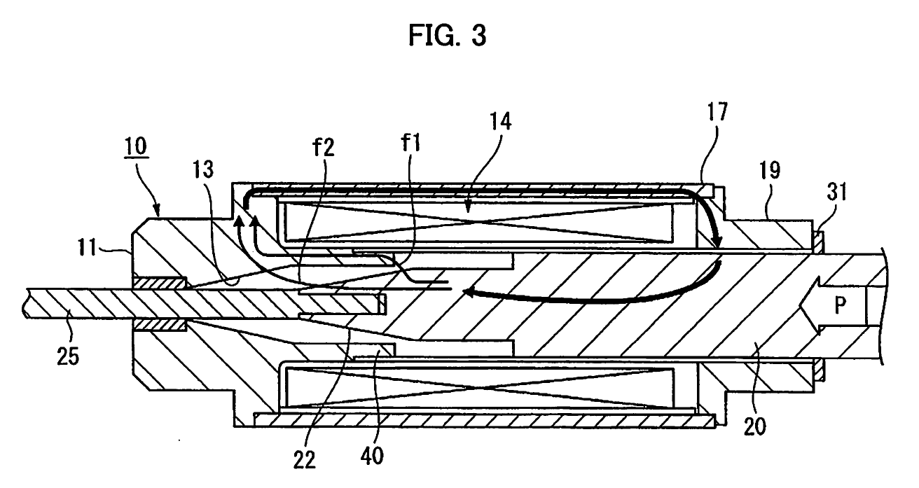

FIG. 1 through FIG. 4 show an electromagnetic actuator of a first embodiment of the present invention, wherein FIG. 1 is a cross sectional view of the electromagnetic actuator, while FIG. 2 through FIG. 4 illustrate in sequential order the relations between the operation states of the electromagnetic actuator and the magnetic flux.

As shown in FIG. 1, an electromagnetic actuator 10 is provided with a fixed magnetic pole 11 and a movable magnetic pole 20 movable along the axial direction of the fixed magnetic pole 11.

The fixed magnetic pole 11 is made of magnetic material and is substantially cylindrical-shaped, wherein an insertion hole 12 is formed in the inside of the fixed magnetic pole 11. The diameter of the insertion hole 12 is the smallest at the anterior edge along the operation direction (the left side as shown in the drawing) of the movable magnetic pole 20, and the insertion hole 12 has a concave tapered portion (concave magnetic portion) 13, wherein the diameter is made gradually enlarged toward the posterior portion (the right side as shown in the drawing) of the movable magnetic pole 20.

Further, a cylinder-shaped electromagnetic coil 14 is mounted in and continuously connected with the fixed magnetic pole 11. The electromagnetic coil 14, in order to induce a magnetic flux between the fixed magnetic pole 11 and the movable magnetic pole 20 so as to attract and operate the movable magnetic pole 20 toward the axial direction of the fixed magnetic pole 11, is wound by a coil wire 15 on a cylindrical bobbin 16 as a winding frame, and the bobbin 16 is mounted at the posterior edge of the fixed magnetic pole 11 along the axial direction so as to further extend toward the further posterior direction. When the electromagnetic coil 14 is combined with the fixed magnetic pole 11, the electromagnetic coil 14 is fixed with the inner circumferential portion of an accommodation cylinder 17 fixed with the posterior portion of the fixed magnetic pole 11. And, there is provided, in the inner circumferential side of the electromagnetic coil 14, a sliding cylinder 18 of a nonmagnetic thin body, thereby mounting the electromagnetic coil 14 to the fixed magnetic pole 11. The posterior edges of the accommodation cylinder 17 and the sliding cylinder 18 are supported by a posterior edge ring 19 at a position further posterior from the electromagnetic coil 14. That is, the electromagnetic coil 14 is mounted between the fixed magnetic pole 11 and the posterior edge ring 19.

On the other hand, the movable magnetic pole 20 is formed of magnetic material similar to that of the fixed magnetic pole 11, and is substantially cylinder-shaped as a whole, wherein the anterior portion (the left side as shown in the drawing) of the movable magnetic pole 20 is formed as the convex tapered portion 22 (the convex magnetic pole portion) in correspondence to the concave tapered portion 13 in the fixed magnetic pole 11. The biggest portion of the posterior edge side of the convex tapered portion 22 as big as it is becomes a small diameter portion 23 of any length along the axial direction. There is provided, at the posterior edge portion of the small diameter portion 23, a large diameter portion 24 whose diameter is greater than that of the posterior edge portion of the small diameter portion 23. The posterior edge side of the large diameter portion 24 is inserted through the posterior edge ring 19 so as to be projected from the posterior direction of the fixed magnetic pole 11. The large diameter portion 24 has an outer diameter slightly smaller than the inner diameter of the sliding cylinder 18, thereby sliding in the sliding cylinder 18. There is provided, at the anterior edge of the large diameter portion 24, the small diameter portion 23, while there is provided, at the anterior edge of the small diameter portion 23, the convex tapered portion 22 whose edge is gradually pointed.

The movable magnetic pole 20 is attracted and moved, in the insertion hole 12 of the fixed magnetic pole 11, from the right side direction to the left side direction as shown in the drawing, when the magnetic circuit between the movable magnetic pole 20 and the fixed magnetic pole 11 is induced by the magnetic flux generated by the electric current supplied into the electromagnetic coil 14. Therefore, the movable magnetic pole 20 is operated from the right side to the left side.

Here, in FIG. 1, the magnetic pole 11 is being drawn slightly separated from the magnetic pole 20, before completing the operation. Further, at the time when the electric current supplied into the electromagnetic coil 14 is stopped, the movable magnetic pole 20 returns back to the right side as shown in FIG. 1 by the elastic force of a not-shown spring (for example, provided at the load side).

Further, the center portion of the anterior edge of the convex tapered portion 22 in the movable magnetic pole 20 is unified with an output axis 25 inserted through the anterior edge portion of the insertion hole 12 of the fixed magnetic pole 11 so as to be projected outside the fixed magnetic pole 11. There is provided, at the opening edge portion (the left side edge portion as shown in FIG. 1) of the insertion hole 12 of the fixed magnetic pole 11, a bearing 30 for sliding and supporting the output axis 25.

Furthermore, there is provided, at the posterior portion of the movable magnetic pole 20, a buffer ring 31 for regulating the operation distance of the movable magnetic pole 20 during the operation of the movable magnetic pole 20 and for reducing an operation noise. Further, an E-shaped stop ring 32 is mounted at the posterior position from the buffer ring 31 and at the outer circumference of the movable magnetic pole 20. The stop ring 32 abuts on the buffer ring 31 at the time when the operation is completed.

And, the electromagnetic actuator 10 is unified with the cylinder-shaped auxiliary magnetic pole 40 at the posterior edge of the fixed magnetic pole 11. The auxiliary magnetic pole 40 is extended, toward the posterior direction of the electromagnetic coil 14, to the halfway position of the axial direction of the electromagnetic coil 14, in such a manner that the posterior edge portion of the fixed magnetic pole 11 is projected outside the small diameter portion 23 of the movable magnetic pole 20. That is, the auxiliary magnetic pole 40 is cylinder-shaped such that the fixed magnetic pole 11 is extended from the posterior edge of the concave tapered portion 13 of the fixed magnetic pole 11. The inner diameter of the auxiliary magnetic pole 40 is set up to be slightly greater than that of the small diameter portion 23 of the movable magnetic pole 20 in such a manner that the auxiliary magnetic pole 40 can be provided and disposed in a ring-like space 35 formed between the small diameter portion 23 and the electromagnetic coil 14.

The electromagnetic actuator 10 of the above-explained structure is disposed by the not-shown spring force in the initial state as shown in FIG. 2 at a position where the movable magnetic pole 20 is separated from the fixed magnetic pole 11, i.e., the movable magnetic pole 20 is disposed at the position shifted toward the right side as shown in FIG. 2. When the electromagnetic actuator 10 is disposed at the above-mentioned state and the DC current is impressed and supplied to the electromagnetic coil 14, the movable magnetic pole 20 is attracted from the right side to the left side as shown by an arrow “P”, resisting against the not-shown spring force.

In the state as shown in FIG. 2, the distance between the concave tapered portion 13 of the fixed magnetic pole 11 and the convex tapered portion 22 of the movable magnetic pole 20 becomes the greatest. However, the distance between the auxiliary magnetic pole 40 and the convex tapered portion 22 of the movable magnetic pole 20 becomes sufficiently small in comparison with the distance between the concave tapered portion 13 of the fixed magnetic pole 11 and the convex tapered portion 22 of the movable magnetic pole 20. This is because the cylinder-shaped auxiliary magnetic pole 40 unified with the fixed magnetic pole 11 is projected toward the posterior position near the movable magnetic pole 20. Thus, the magnetic flux is generated, passing as shown by an arrow “f1” between the auxiliary magnetic pole 40 and the convex tapered portion 22 of the movable magnetic pole 20. Thus, the magnetic flux passes trough the fixed magnetic pole 11, the accommodation cylinder 17, posterior edge ring 19, and both the large diameter portion 24 and the small diameter portion 23 of the movable magnetic pole 20. As a result, the movable magnetic pole 20 starts operating.

Then, accompanied by the operation of the movable magnetic pole 20, the distance between the convex tapered portion 22 of the movable magnetic pole 20 and the concave tapered portion 13 of the fixed magnetic pole 11 becomes gradually small, thereby allowing the magnetic flux to flow as shown by an arrow “f2” which is gradually increased and continuously operates the movable magnetic pole 20. Also in this case, the magnetic flux continues flowing as shown by the arrow “f1” between the convex tapered portion 22 of the movable magnetic pole 20 and the auxiliary magnetic pole 40 of the fixed magnetic pole 11.

That is, the following two flow routes of the magnetic fluxes “f1” and “f2” are generated between the fixed magnetic pole 11 and the movable magnetic pole 20. One of the magnetic fluxes, “f1” flows between the auxiliary magnetic pole 40 and the convex tapered portion 22, while another magnetic flux “f2” flows between the concave tapered portion 13 and the convex tapered portion 22.

Thereafter, when the movable magnetic pole 20 further operates and the convex tapered portion 22 comes near the concave tapered portion 13 of the fixed magnetic pole 11 so as to abut on the concave tapered portion 13 of the fixed magnetic pole 11, the magnetic flux “f2” is further increased between the convex tapered portion 22 of the movable magnetic pole 20 and the concave tapered portion 13 of the fixed magnetic pole 11. And, the convex tapered portion 22 of the movable magnetic pole 20 is operated toward the position substantially abutting on the concave tapered portion 13 of the fixed tapered portion 11. And, at the time when the stop ring 32 abuts on the buffer ring 31, the movable magnetic pole 20 stopped at the abutment position.

Here, the arrow line heaviness as shown by “f1” and “f2” as shown in FIG. 2 through FIG. 4 is changed, as the magnetic flux increases. Further, when the electric current supplied into the electromagnetic coil 14 is stopped after completing operating the movable magnetic pole 20 in the above-explained manner, the movable magnetic pole 20 returns back to the original position as shown in FIG. 2 due to the elastic force of the not-shown spring, because the attracting force exerted on the movable magnetic pole 20 is removed.

In this way, even in the case where the distance between the concave tapered portion 13 of the fixed magnetic pole 11 and the convex tapered portion 22 of the movable magnetic pole 20 is so great that the magnetic flux there-between is hardly generated, the magnetic flux as shown by the arrow “f1” as shown in FIG. 2 is generated between the auxiliary magnetic pole 40 extending toward the posterior direction of the fixed magnetic pole 11 and the movable magnetic pole 20, so as to operate the movable magnetic pole 20. Therefore, the operation is surely started, even in the case where the long operation distance is required.

Therefore, unlike the conventional techniques, it is not required that the tapered portions 13 and 22 be made extremely long along the axial direction, and further it is not required that any special conversion mechanism and so on be provided. Moreover, because of such a simple structure that only a part of the fixed magnetic pole 11 is extended so as to provide the auxiliary magnetic pole 40, the electromagnetic actuator 10 as a whole is not prevented from being made compact.

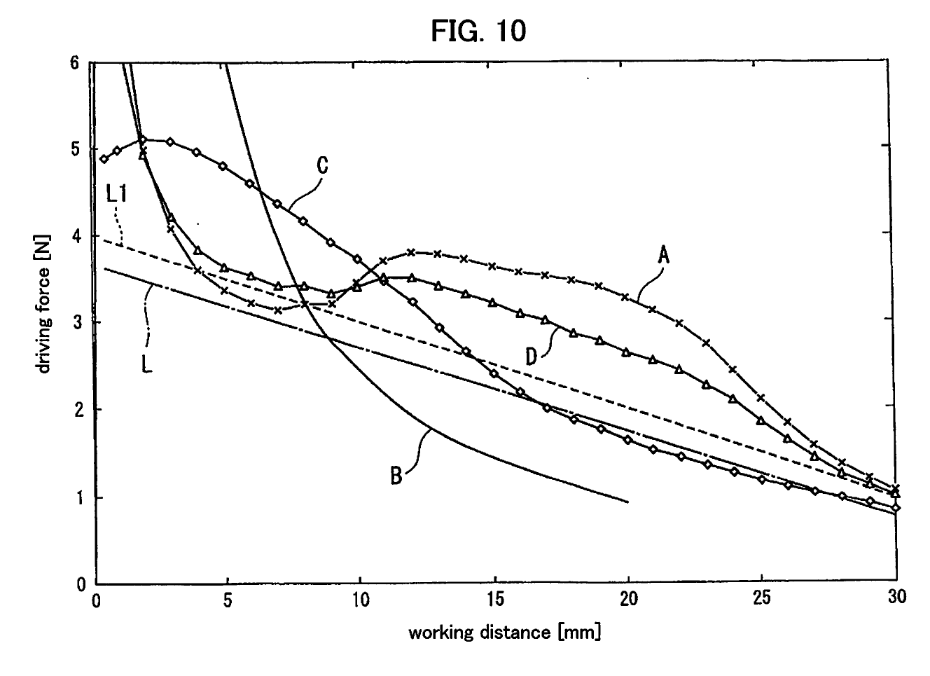

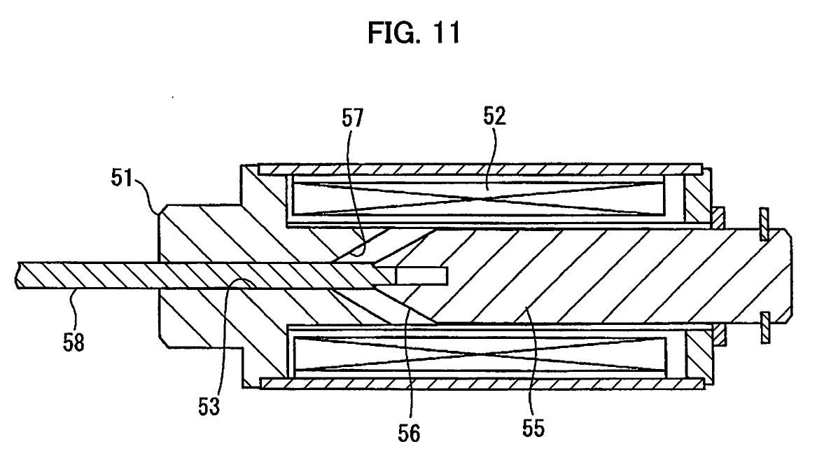

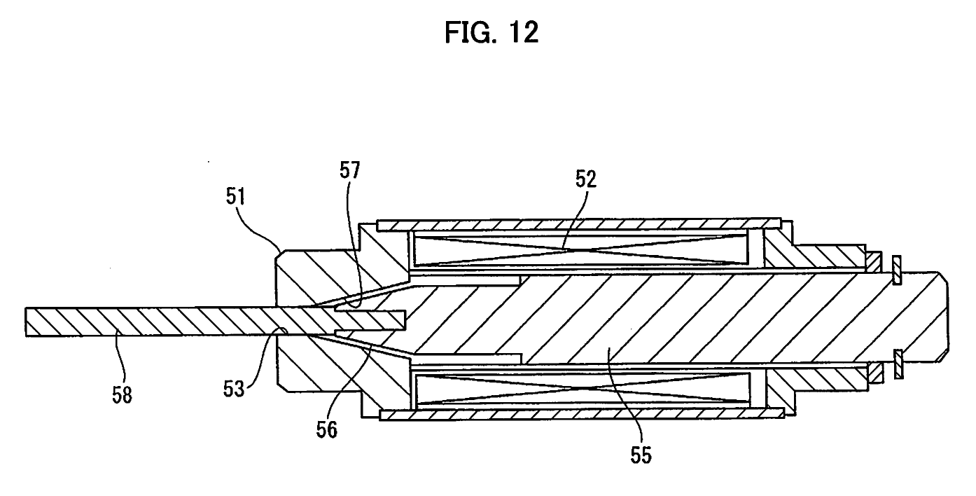

In this connection, FIG. 10 shows a curve “A” of a measurement result of a characteristic of the electromagnetic actuator of the present embodiment. FIG. 10 includes the operation distance vs. propulsion force characteristic curves, wherein the axis of abscissas is the stroke (operation distance) of the movable magnetic pole, while the axis of ordinates is the magnitude of the propulsion force exerted on the movable magnetic pole. The curve “A” shows a characteristic of the electromagnetic actuator 10 of the present embodiment, the curve “B” shows a characteristic of the electromagnetic actuator of the first conventional technique as shown in FIG. 11, the curve “C” shows a characteristic of the electromagnetic actuator of the second conventional technique as shown in FIG. 12, and “L” shows a magnitude of a load (spring).

As shown in FIG. 10, at the stroke greater than 9 millimeters on the curve “B”, the propulsion force becomes smaller than the load “L”. As a result, the actuator cannot be operated, and therefore, the stroke is applicable only for less than 9 millimeters. Although the operation distance for the curve “C” is longer than that for the curve “B”, the operation distance for the curve “C” is extended over no longer than about 16 millimeters.

On the contrary, it is understood that the propulsion force obtained for the curve “A” is always greater than the load “L”, up to the stroke of 30 millimeters within the shown range of the operation distance vs. propulsion force characteristic chart. According to the electromagnetic actuator 10, the operation distance can be surely made greater, and moreover the movable magnetic pole 20 can be stably operated even in the case where the operation distance becomes greater.

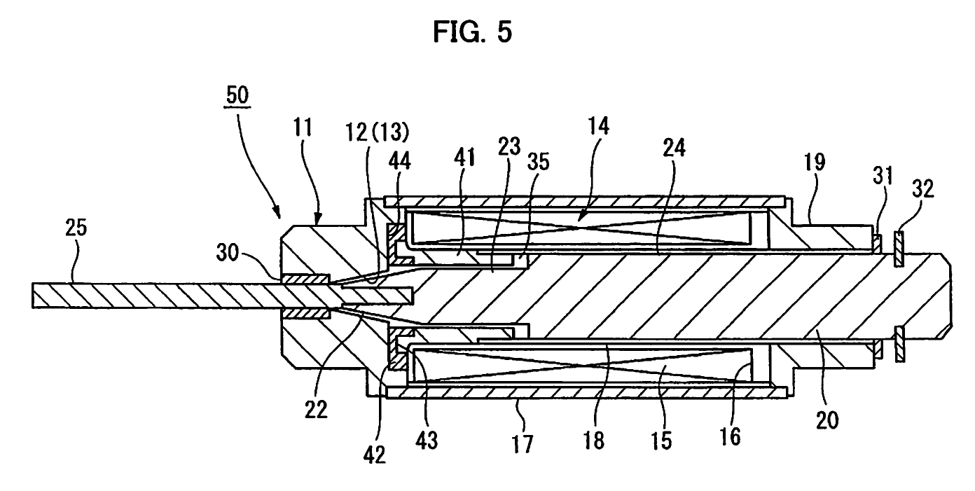

FIG. 5 through FIG. 9 show an electromagnetic actuator of the second embodiment. The electromagnetic actuator 50 of the second embodiment is different from the first embodiment only in that the cylinder-shaped auxiliary magnetic pole 41 is separated from the fixed magnetic pole 11, and in that the nonmagnetic member 42 is provided between the fixed magnetic pole 11 and the auxiliary magnetic pole 41.

That is, the nonmagnetic member 42 is ring-shaped, and a ring-shaped concave portion 43 fitted into the anterior edge of the cylinder-shaped auxiliary magnetic pole 41 is formed at the posterior edge of the nonmagnetic member 42. The nonmagnetic member 42 is fitted into a ring-shaped concave portion 44 formed at the posterior edge of the fixed magnetic pole 11, whereby the fixed magnetic pole 11, the nonmagnetic member 42, and the auxiliary magnetic pole 41 are unified in this order. Other elements similar to those in FIG. 1 are referred to by the similar reference numerals in FIG. 5 through FIG. 9.

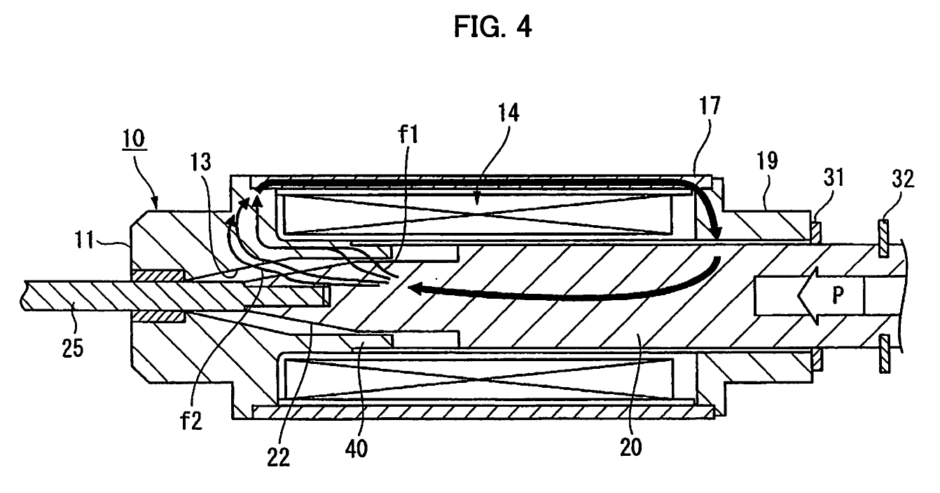

Incidentally, due to the generation of the magnetic flux through the auxiliary magnetic pole 40 in the electromagnetic actuator 10 in the first embodiment, the propulsion force is greater than the load “L” within the range of the operation distance of the movable magnetic pole 20 as shown by the curve “A” of FIG. 10. However, the magnetic flux is also generated between the small tapered portion 23 and the auxiliary magnetic pole 40 along the radial direction as shown by the arrow “f1” as shown in FIG. 4, after the small tapered portion 23 of the movable magnetic pole 20 entered into the auxiliary magnetic pole 40.

Accordingly, the quantity of the magnetic flux (f2) passing between both tapered portions 22 and 13 increases, as the convex tapered portion 22 of the movable magnetic pole 20 approaches the concave tapered portion 13 of the fixed magnetic pole 11. However, the propulsion force along the axial direction is reduced by the effect of the attractive force exerted on the movable magnetic pole 20 along the radial direction. As a result, the propulsion force drops down near the stroke of 7 millimeters, concretely near 4 through 9 millimeters as shown in FIG. 10.

On the contrary, there is provided, in the electromagnetic actuator 50, the nonmagnetic member 42, so as to separate the fixed magnetic pole 11 from the auxiliary magnetic pole 41 as stated above. Therefore, the magnetic flux from the small tapered portion 23 of the movable magnetic pole 20 through the auxiliary magnetic pole 41 can be suppressed by the nonmagnetic member 42.

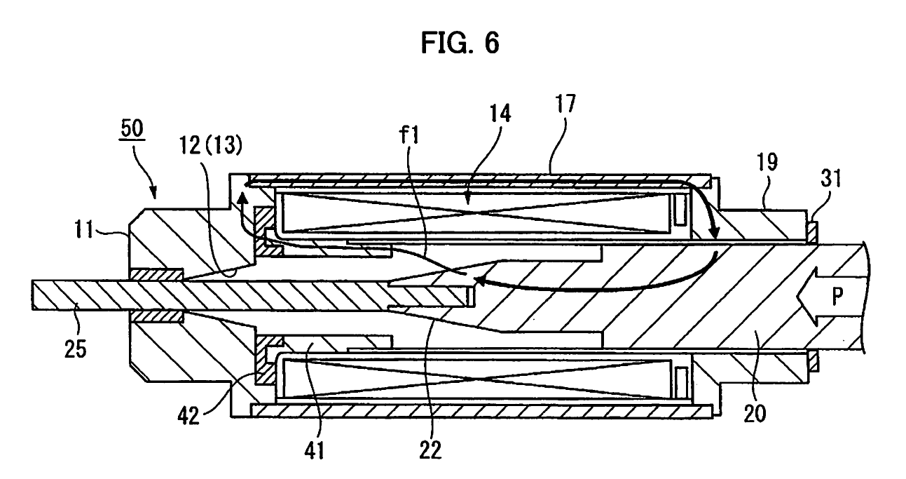

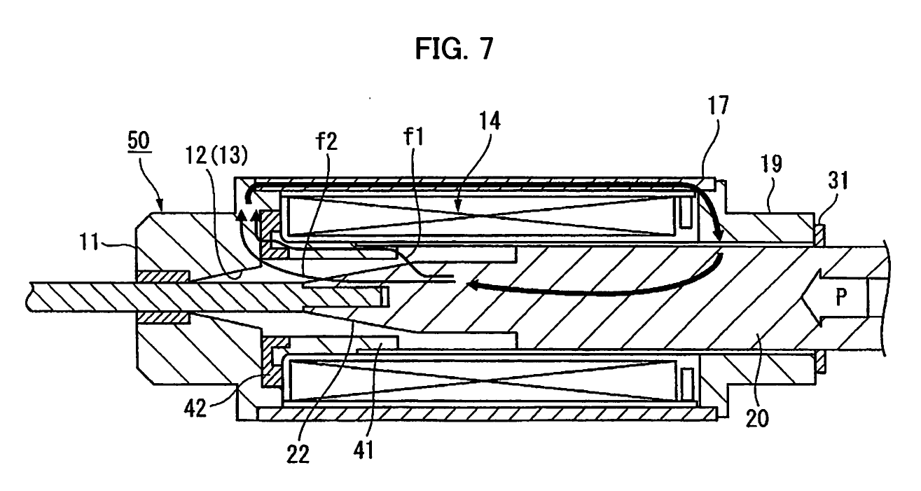

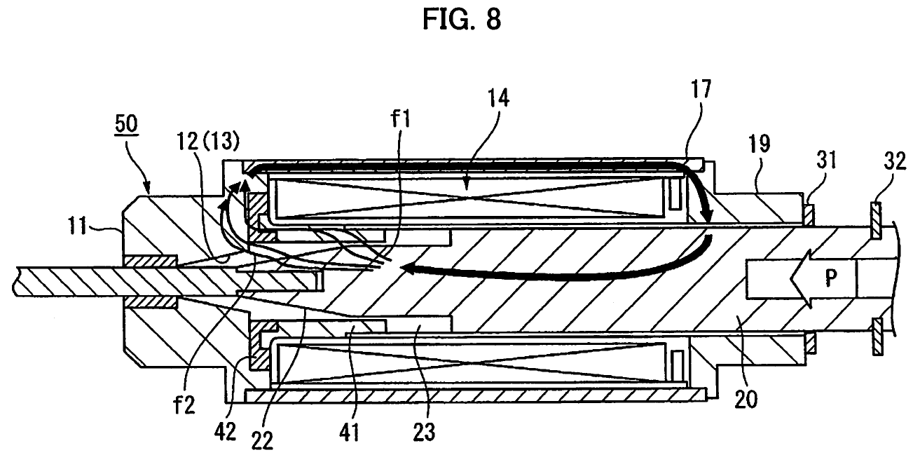

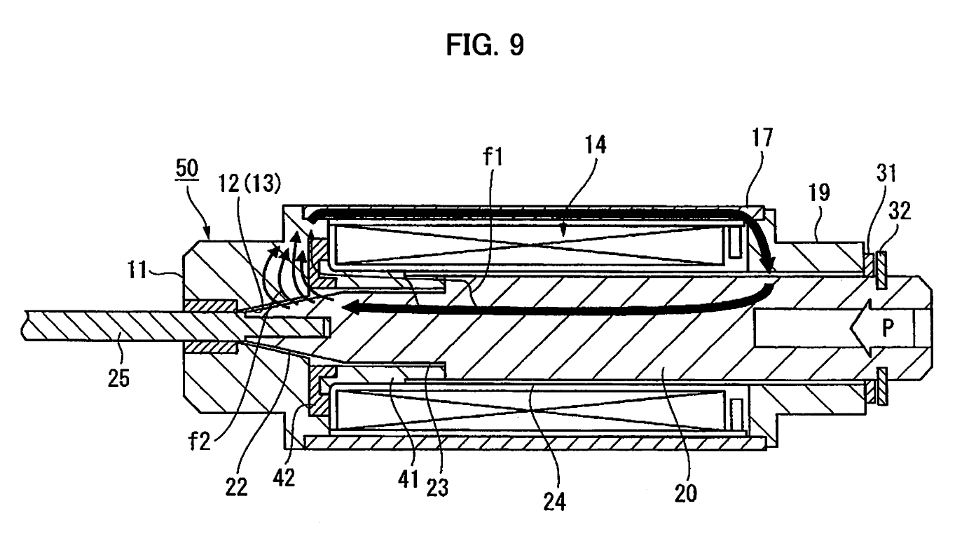

This magnetic flux suppression is explained, referring to FIG. 6 through FIG. 9. In the initial state as shown in FIG. 6, the magnetic flux as shown by the arrow “f1” is generated, by the electric current supplied into the electromagnetic coil 14, between the convex tapered portion 22 of the movable magnetic pole 20 and the auxiliary magnetic pole 41. As a result, the movable magnetic pole 20 is attracted. The magnetic flux “f1” becomes smaller than that of the first embodiment, due to the interposition of the nonmagnetic member 42 between the auxiliary magnetic pole 41 and the fixed magnetic pole 11. Then, as shown in FIG. 7, when the convex tapered portion 22 of the movable magnetic pole 20 approaches the concave tapered portion 13 of the fixed magnetic pole 11, the magnetic field as shown by the arrow “f2” is also generated. Further, as shown in FIG. 8, the convex tapered portion 22 of the movable magnetic pole 20 enters into the auxiliary magnetic pole 41, thereby strengthen the magnetic flux between both tapered portions 22 and 13 of the movable magnetic pole 20 and the fixed magnetic pole 11, respectively. As shown in FIG. 9, as the distance between both tapered portions 22 and 13 becomes smaller, the magnetic flux (f2) between both tapered portions 22 and 13 becomes sufficiently dominant, in comparison with the relatively small magnetic flux (f1), thereby enabling to exert a great propulsion force on the movable magnetic pole 20 to the posterior edge side of the operation distance.

The curve “D” as shown in FIG. 10 shows a change in the propulsion force in a series of the steps. As clearly shown by the curve “D”, when the distance between the fixed magnetic pole 11 and the movable magnetic pole 20 is great, for example, near the stroke of 20 millimeters, the magnetic flux (f1) generated between the movable magnetic pole 20 and the auxiliary magnetic pole 41 is smaller than that of the first embodiment. Therefore, the propulsion force of the curve “D” of the second embodiment is smaller than that of the curve “A” in the first embodiment. On the contrary, the drop-down quantity becomes small near the stroke 4 millimeters through 9 millimeters where the propulsion force drops down. Therefore, the propulsion force for the curve “D” is conversely increased in comparison with the curve “A”. This is because the magnetic flux (f1) through the auxiliary magnetic pole 41 is decreased due to the presence of the nonmagnetic member 42. As a result, as stated above, the attractive force between both tapered portions 22 and 13 along the axial direction becomes dominant in comparison with the attractive force exerted on the movable magnetic pole 20 along the radial direction, when the movable magnetic pole 20 enters into the auxiliary magnetic pole 41.

Accordingly, as shown by the operation distance vs. propulsion force characteristic curve “D” as shown in FIG. 10, the operation can be executed sufficiently stably in the entire range within the stroke of 30 millimeters.

Further, such a propulsion force characteristic results in the excellent operation even under an increased load. That is, even in the case where the load is increased from “L” to “L1”, the propulsion force is greater than the load in the entire range of the stroke of 30 millimeters, thereby surely holding the longer stroke even for the heavier load.

Here, it is needless to say that the characteristics can be adjusted by changing the slant angles of the tapered portions of the fixed magnetic pole 11 and the movable magnetic pole 12, the size of the small diameter portion, the thickness and the length along the axial direction of the auxiliary magnetic pole, and other sizes.

Further, although in each embodiment the tapered shape was formed in each embodiment, any convex or concave stepped form may be preferable. In the claims, those tapered members, stepped members and so on are referred to as convex tapered portion and concave tapered portion.

Further, in the above-explained embodiments, the fixed magnetic pole was provided with the concave magnetic pole portion and the movable magnetic pole was provided with the convex magnetic pole portion. However, conversely, the fixed magnetic pole may be provided with a convex magnetic pole, while the movable magnetic pole may be provided with a concave magnetic pole portion. In this case, the movable magnetic pole is provided with the auxiliary magnetic pole.

Furthermore, although in each of the above-explained embodiments the auxiliary magnetic pole was cylinder-shaped in each embodiment, the shape is not limited to the cylinder but also may be such a structure that a plurality of divided parts, e.g., arch forms in their cross sections may be disposed along the circumferential direction.

1. An electromagnetic actuator, comprising:
an insertion hole along an axial direction of said electromagnetic actuator;
a fixed magnetic pole provided with an electromagnetic coil;
a movable magnetic pole movable along said axial direction provided in said insertion hole;
a convex magnetic pole portion, provided at either one of said fixed magnetic pole or said movable magnetic pole, and
projected along a moving direction of said movable magnetic pole toward another one of said fixed magnetic pole or said movable magnetic pole; and
a concave magnetic pole portion formed, at said another one of said fixed magnetic pole or said movable magnetic pole, in correspondence to said convex magnetic pole portion, characterized in that an auxiliary magnetic pole is continuously provided at said concave magnetic pole portion, and is extended from an opening edge of said concave magnetic pole portion.

2. The electromagnetic actuator according to claim 1, characterized in that a nonmagnetic member is disposed between said concave magnetic pole portion and said auxiliary magnetic pole.

3. The electromagnetic actuator according to claim 2, characterized in that said auxiliary magnetic pole is divided into a plurality of parts along a circumferential direction side.
